(19) United States
(12) Patent Application Publication
(10) Pub. No.: US 2014/0354803 A1
(43) Pub. Date: Dec. 4, 2014

(54) INFORMATION PROCESSING APPARATUS, CONTROL METHOD THEREFOR, AND COMPUTER-READABLE STORAGE MEDIUM

(71) Applicant: CANON KABUSHIKI KAISHA, Tokyo (JP)

(72) Inventor: Makoto Chida, Kunitachi-shi (JP)

(21) Appl. No.: 14/361,481

(22) PCT Filed: Nov. 7, 2012
(86) PCT No.: PCT/JP2012/079444

§ 371 Date: May 29, 2014

(30) Foreign Application Priority Data
Dec. 19, 2011 (JP) 2011-277658

(51) Int. Cl. G01B 11/25

(52) U.S. Cl. CPC G01B 11/254
USPC 348/136

(57) ABSTRACT

An information processing apparatus comprises projection means for projecting a projection pattern generated by a display device onto a target object by turning on a variable ON/OFF light source; image capture means for capturing an image of the target object onto which the projection pattern is projected; calculation means for calculating an image capture period of said image capture means based on a response property of the display device and image capture characteristics of said image capture means; and control means for controlling to synchronize the image capture period of said image capture means and a projection period of said projection means by keeping the light source ON during the image capture period.

### TECHNICAL FIELD

The present invention relates to an information processing apparatus, a control method therefor, and a computer-readable storage medium.

### BACKGROUND ART

In the field of industrial machine vision, three dimensional measurement techniques are known as technology components. A method of performing three dimensional measurement using machine vision will briefly be described hereinafter. First, a target object to be measured is irradiated with light which bears the information of a two dimensional pattern, and an image of the target object to be measured onto which the two dimensional pattern is projected is captured by a camera. Then, based on the periodicity of the two dimensional pattern, the captured image is analyzed to obtain distance information to the target object to be measured. This distance information indicates the distance from the camera to the target object to be measured or the depth of, for example, the three dimensional surface structure. Because information in the widthwise and height directions can be obtained from the two dimensional captured image, three dimensional space information is obtained at this time. Lastly, three dimensional model fitting is performed using the two dimensional captured image, the distance information, and the model information of the target object to be measured held in advance, thereby measuring the position, orientation, and three dimensional shape of the target object to be measured.

This technique is often used to, for example, pick up or assemble components by a robot arm in a factory manufacturing line. The positions, orientations, and three dimensional shapes of components are measured using the three dimensional measurement technique, and the robot arm is controlled based on the obtained information, thereby allowing the robot arm to efficiently, accurately pick up and assemble the components.

As a three dimensional method which uses a two dimensional pattern, the spatial coding method or the phase shift method, for example, is available. These methods are effective because they can simultaneously be used for an image recognition process. Also, a pattern projection operation which uses a projector can variably project different patterns, and is therefore effective in a three dimensional measurement method, which requires a plurality of patterns, such as the spatial coding method or the phase shift method. Note that the projector can project different patterns upon switching between them at a frame rate of 30 fps to 60 fps or more. Because the camera can capture an image at a high frame rate as well, and the projector and camera resolutions have improved, three dimensional measurement can be performed with high speed and high accuracy as long as different patterns can variably be measured for each frame.

Japanese Patent Laid-Open No. 2009-186404 discloses a technique of synchronizing an operation of turning on an illumination light source to illuminate an object in obtaining two dimensional image information, and an operation of turning on a projection light source to project a geometric pattern onto the object in obtaining three dimensional image information.

Japanese Patent No. 2997245 discloses a technique of sequentially switching between a plurality of pattern masks, and making an electronic flash light source emit light for every switching operation, thereby capturing an image.

Japanese Patent Laid-Open No. 7-234929 discloses a technique in which assuming that a CCD (Charge-Coupled Device) is used as an image sensor, the image input period (full-pixel simultaneous input) and the image output period are clearly separated, and the projection pattern is switched during the image output period.

Unfortunately, the above-mentioned related art techniques pose the following problem. A high-pressure mercury lamp is the current mainstream projector light source. Unlike a halogen lamp, the mercury lamp uses no filaments, and therefore has a relatively long life, but requires component replacement every few months when it is always kept ON for the industrial purpose. Also, it takes much time for the mercury lamp to become stable after turn-on, so the mercury lamp must be kept ON during the required process time once it is turned on. This is disadvantageous in terms of not only wastefully keeping the mercury lamp ON during a time other than the measurement time, but also making it necessary to suppress an increase in temperature as the mercury lamp must be kept ON for a long time.

Furthermore, none of Japanese Patent Laid-Open No. 2009-186404, Japanese Patent No. 2997245, and Japanese Patent Laid-Open No. 7-234929 accurately control light emission within one frame in accordance with the projection and image capture characteristics.

Conventionally, a light source is kept ON because a high-pressure mercury lamp is used as the light source, but the use of a variable ON/OFF light source (for example, an LED light source) allows operations as in the related art techniques. Further, a measurement apparatus which uses an optimum light source effective in terms of both heat removal and energy saving can be achieved by finer LED ON/OFF control, in which the LED is turned on only within the period required for measurement.

### SUMMARY OF INVENTION

The present invention has been made in consideration of the above-mentioned problem, and provides a technique of shortening the ON time of a light source to prevent an increase in temperature of the light source, thereby allowing life prolongation and power saving of the light source.

According to one aspect of the present invention, there is provided an information processing apparatus comprising: projection means for projecting a projection pattern generated by a display device onto a target object by turning on a variable ON/OFF light source; image capture means for capturing an image of the target object onto which the projection pattern is projected; calculation means for calculating an image capture period of the image capture means based on a response property of the display device and image capture characteristics of the image capture means; and control means for controlling to synchronize the image capture period of the image capture means and a projection period of the projection means by keeping the light source ON during the image capture period.

According to one aspect of the present invention, there is provided a control method for an information processing apparatus including projection means, image capture means, calculation means, and control means, the method comprising: a projection step of causing the projection means to project a projection pattern generated by a display device onto a target object by turning on a variable ON/OFF light source; an image capture step of causing the image capture means to capture an image of the target object onto which the projection pattern is projected; a calculation step of causing the calculation means to calculate an image capture period of the image capture means based on a response property of the display device and image capture characteristics of the image capture means; and a control step of causing the control means to control to synchronize the image capture period of the image capture means and a projection period of the projection means by keeping the light source ON during the image capture period.

Further features of the present invention will become apparent from the following description of exemplary embodiments with reference to the attached drawings.

### BRIEF DESCRIPTION OF DRAWINGS

FIG. 1 is a block diagram showing the configuration of a three dimensional measurement apparatus in the first embodiment (setting of the synchronization timing in advance);

FIGS. 2A and 2B are timing charts showing the operation timings of a projection unit and image capture unit, respectively, in the first embodiment;

FIG. 3 is a block diagram showing the internal configuration of a synchronization control unit in the first embodiment;

FIG. 4 is a timing chart showing the synchronization timing between projection and image capture, and the light source ON operation in the first embodiment (entire area);

FIG. 5 is a timing chart showing the synchronization timing between projection and image capture, and the light source ON operation in the second embodiment (image capture of a partial area using the rolling shutter scheme);

FIG. 6 is a timing chart showing the synchronization timing between projection and image capture, and the light source ON operation in the second embodiment (image capture of a partial area using the global shutter scheme);

FIG. 7 is a timing chart showing the synchronization timing between projection and image capture, and the light source ON operation in the third embodiment (ON of only the white portion of a projection pattern);

FIG. 8 is a view showing the relationship between the measurement distance and each of projection and image capture areas in the fourth embodiment;

FIG. 9 is a timing chart showing the synchronization timing between projection and image capture, and the light source ON operation in the third embodiment (setting of the ON period longer than the image capture period);

FIG. 10 is a block diagram showing the configuration of a three dimensional measurement apparatus in the fifth embodiment (obtaining of the characteristic information of a camera and projector to generate a synchronization timing);

FIGS. 11A and 11B are block diagrams showing the internal configurations of projection devices in the sixth embodiment (projection devices capable of controlling light sources); and

FIG. 12 is a timing chart showing the projection and light source ON timings in the sixth embodiment.

### DESCRIPTION OF EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

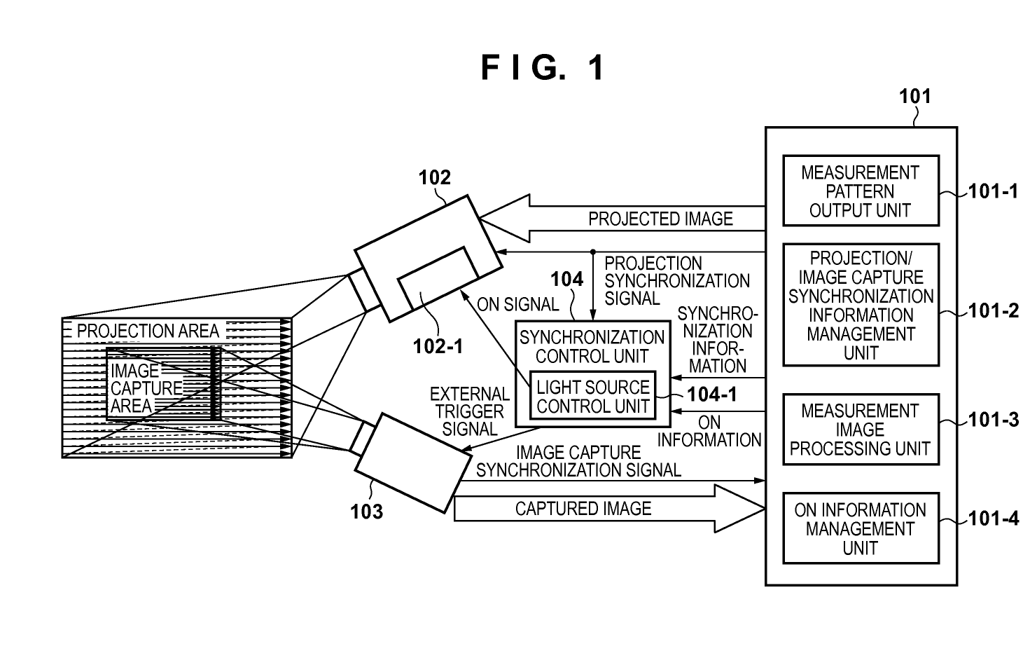

The configuration of a three dimensional measurement apparatus which functions as an information processing apparatus in the first embodiment will be described with reference to FIG. 1. The three dimensional measurement apparatus includes an overall control unit 101, projection unit 102, image capture unit 103, and synchronization control unit 104.

The overall control unit 101 includes a measurement pattern output unit 101-1, projection/image capture synchronization information management unit 101-2, measurement image processing unit 101-3, and ON information management unit 101-4. The projection unit 102 includes a light source unit 102-1. The synchronization control unit 104 includes a light source control unit 104-1.

The overall control unit 101 controls each processing unit including the measurement pattern output unit 101-1, projection/image capture synchronization information management unit 101-2, measurement image processing unit 101-3, and ON information management unit 101-4, and controls information exchange between the overall control unit 101 and the projection unit 102, image capture unit 103, or synchronization control unit 104.

The measurement pattern output unit 101-1 generates a projection pattern image to be used for measurement. The measurement pattern output unit 101-1 transmits the projection pattern image to the projection unit 102.

The projection/image capture synchronization information management unit 101-2 stores, in advance, and manages synchronization information for synchronizing the projection start timing of the projection unit 102 and the image capture start timing of the image capture unit 103. The projection/image capture synchronization information management unit 101-2 reads out the synchronization information, and transmits it to the light source control unit 104-1.

The measurement image processing unit 101-3 receives and analyzes image data captured by the image capture unit 103 to extract pattern edge position information. The measurement image processing unit 101-3 then creates a distance information map to a target object to be measured using the principle of triangulation, based on the baseline length between the projection unit 102 and the image capture unit 103, and the distance to the target object to be measured.

The ON information management unit 101-4 generates ON information for controlling the ON timing of the variable ON/OFF light source unit 102-1 of the projection unit 102. The ON information management unit 101-4 transmits the ON information to the synchronization control unit 104.

The projection unit 102 projects a projection pattern onto the target object to be measured. The image capture unit 103 captures an image of the target object to be measured onto which the projection pattern is projected by the projection unit 102.

The synchronization control unit 104 adjusts the start timing of projection by the projection unit 102, and the start timing of image capture by the image capture unit 103, based on the received ON information and synchronization information, thereby controlling their synchronization, in order to control the projection unit 102 and the image capture unit 103 at high speed for each frame in three dimensional measurement by pattern projection.

More specifically, the overall control unit 101 controls the measurement pattern output unit 101-1 to transmit a projection pattern image which is generated by the measurement pattern output unit 101-1 and to be used for measurement to the projection unit 102. The overall control unit 101 also controls the ON information management unit 101-4 to transmit ON information generated by the ON information management unit 101-4 to the synchronization control unit 104.

The projection unit 102 receives the projection pattern image from the measurement pattern output unit 101-1, and drives a display unit (not shown). The projection unit 102 also receives the ON information from the synchronization control unit 104. The projection unit 102 then projects the projection pattern onto the target object to be measured after turn-on of the light source unit 102-1.

The image capture unit 103 captures an image of the target object that is to be measured onto which the projection pattern is projected, and transmits the captured image to the overall control unit 101. The overall control unit 101 receives image data captured by the image capture unit 103. The measurement image processing unit 101-3 analyzes the received image data to extract pattern edge position information. The measurement image processing unit 101-3 then creates a distance information map to the target object to be measured using the principle of triangulation, based on the baseline length between the projection unit 102 and the image capture unit 103, and the distance to the target object to be measured.

Although the horizontal scanning direction of projection by the light source unit 102-1 and that of image capture by the image capture unit 103 are set to be the same in FIG. 1, these two horizontal scanning directions may be opposite to each other.

However, if an image is captured using the line-sequential display scheme or the rolling shutter scheme, the sub-scanning direction of the projection unit 102 (that is, a direction perpendicular to the horizontal scanning direction and in which line scanning sequentially progresses when one frame is formed by a plurality of lines) and the sub-scanning direction of the image capture unit 103 are set to be the same. This makes it possible to reduce the difference in scanning position between scanning by the projection unit and scanning by the image capture unit due to the elapse of time.

The image capture unit 103 also has a function for capturing an image upon setting the image capture area to an arbitrary partial area that falls within the range of the projection area of the projection unit 102 by ROI (Region Of Interest) control, as shown in FIG. 1. This allows an improvement in efficiency and a speedup of a process associated with image capture.

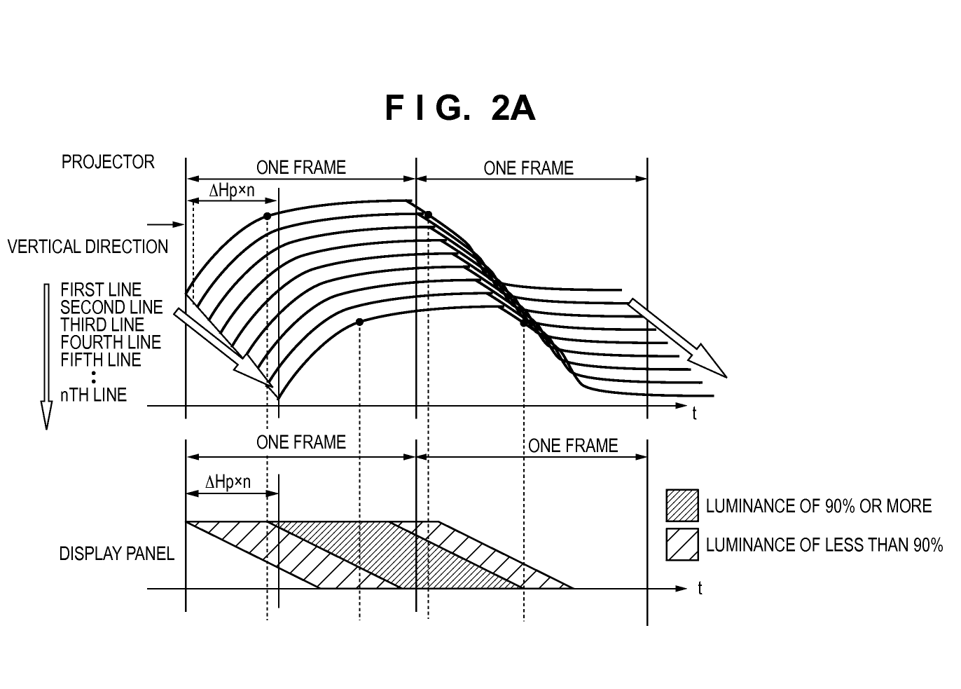

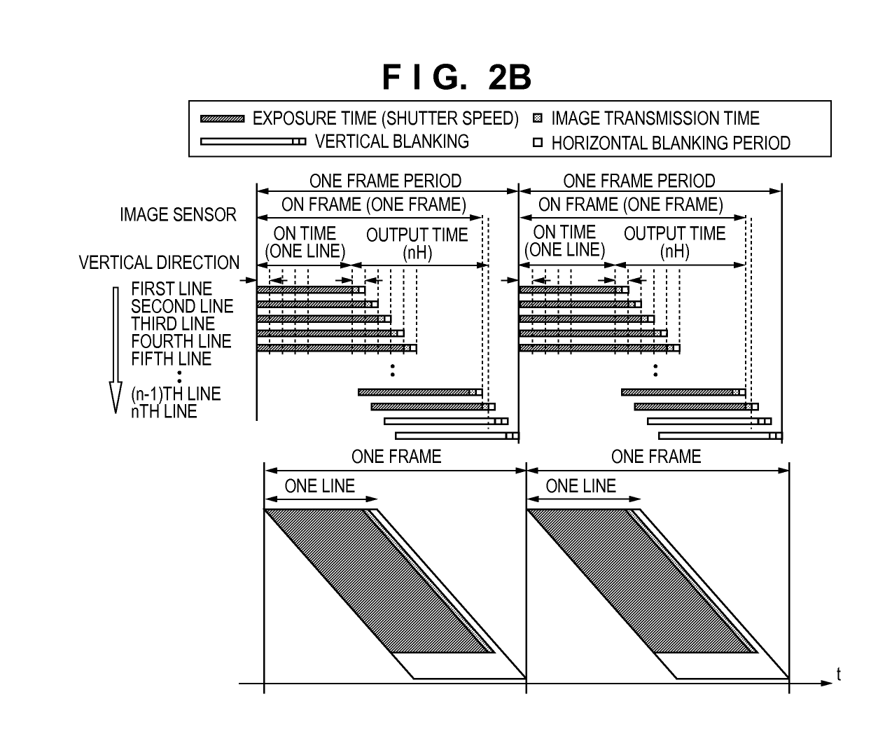

FIGS. 2A and 2B are timing charts showing the operation timings of the projection unit 102 and image capture unit 103, respectively, in line-sequential display and rolling shutter image capture, that are especially hard to adjust.

As the projector, a liquid crystal display device type projector, for example, is widely used. A liquid crystal projector generally adopts the active matrix driving scheme. In the active matrix driving scheme, scanning voltages are sequentially applied to scanning lines (signal lines) for each horizontal scanning period to, in turn, sequentially apply predetermined voltages to corresponding pixel electrodes so as to drive the liquid crystal projector, thereby constructing a display image.

Note that driving schemes are roughly classified into the frame-sequential driving scheme and the line-sequential driving scheme, depending on a method of applying a voltage to a signal line. The frame-sequential driving scheme is used to apply a voltage to a signal line corresponding to an input video signal, while the line-sequential driving scheme is used to apply a voltage to a signal corresponding to each video signal at once after a video signal of one line is temporarily latched. The line-sequential driving scheme is commonly used. However, in the line-sequential driving scheme, a pattern cannot simultaneously be projected to the entire field, so a display image having lines set in different driven states is obtained at a certain time point. Further, a mixture of the previous frame image and the current frame image is displayed within one field, so it is very difficult to use the line-sequential driving scheme in projecting a plurality of patterns.

FIG. 2A shows the operation timing of the projection unit 102 when the active matrix, line-sequential driving scheme is used. The upper part of FIG. 2A shows a variation in projection start time of each line and a temporal change in amount of projected light in the horizontal scanning direction in a liquid crystal projector which uses the line-sequential driving scheme. The ordinate indicates the projection position represented by the line number, and signal lines are scanned in the top-to-bottom direction as the sub-scanning direction (vertical direction). The abscissa indicates a time corresponding to the periods of two frames, and a white pattern (high luminance value) is projected in the first frame, while a black pattern (low luminance value) is projected in the second frame. Note that in this case, for the sake of convenience, a projection pattern is represented by a white pattern and a black pattern. However, when a vertical striped pattern formed by spatial coding is projected, a change in luminance corresponding to the vertical striped pattern formed by spatial coding occurs in the horizontal or vertical direction within one frame.

As can be seen from the foregoing description, the temporal change in projection luminance of each line is nearly the same, but a change in amount of light occurs depending on the projection position at the same time instant, because the projection start time varies in each individual line. This temporal change in projection luminance occurs due to factors associated with the response property of the liquid crystal device.

In the active matrix driving scheme, a voltage applied to a gate electrode line turns on all FETS (Field Effect Transistors) of one column connected to it, so a current is supplied between their sources and drains, the voltage applied to each source electrode line at that time is applied to a liquid crystal electrode, and a charge corresponding to the voltage is stored in a corresponding capacitor. After the charging operation of one column via the gate electrode line ends, the voltage application sequence shifts to the next column, and the FETs of the first column are turned off upon losing their gate voltages. However, although the liquid crystal electrodes of the first column lose their voltages from the source electrode lines, they can keep almost the required voltages during the period corresponding to one frame until the next gate electrode line is selected. Note that the response time of a liquid crystal panel is longer than that of a cathode-ray tube or PDP (Plasma Display Panel), which is on the order of about 1 microsecond. This is because in the liquid crystal panel, a physical change in orientation of a liquid-phase liquid crystal substance is used in display and, more specifically, a lag of a change in orientation is determined upon defining the liquid crystal viscosity and layer thickness as the main parameters. The period from the start of projection until a predetermined amount of light is reached can be calculated based on the response property of the liquid crystal device. Also, the image capture period can be predicted from the calculation result. Moreover, the period in which light in an amount sufficient for measurement can be projected can be calculated, so a synchronization timing can be generated so as to capture an image within the period in which measurement is possible. The lower part of FIG. 2A shows the outline of the operation of the display panel described earlier with reference to the upper part of FIG. 2A.

FIG. 2B shows the operation timing of a CMOS sensor serving as the image capture unit 103 in the rolling shutter scheme. Cameras which use CCDs have conventionally been prevalent, while enormous numbers of cameras, videos, and mobile phones equipped with CMOS sensors are currently prevailing. This is accounted for by progress in power saving and an increase in resolution. In addition, by virtue of a dramatic improvement in sensitivity performance of CMOS sensors, which was inferior to that of CCDs in the past, CMOS sensors have become widely popular.

A CCD sensor implemented by CCDs includes two dimensionally arrayed photodiodes, vertical CCDs, horizontal CCDs, and output amplifiers. A charge photoelectrically converted by the photodiode is sequentially transferred via the vertical CCD and horizontal CCD, converted into a voltage by the output amplifier, and output as a voltage signal. Note that since the charges stored in the vertical CCDs and horizontal CCDs function as one frame memory, the exposure time and the readout time can be separated to allow full-pixel simultaneous exposure. On the other hand, a CMOS sensor includes a photodiode, a horizontal/vertical MOS switch matrix, horizontal and vertical scanning circuits which sequentially scan horizontal and vertical lines, respectively, and an output amplifier. A charge photoelectrically converted by the photodiode turns on the vertical MOS switch as a shift pulse from the vertical scanning circuit reaches it, and turns on the horizontal MOS switch as a shift pulse from the horizontal scanning circuit reaches it.

At this time, because of the horizontal/vertical matrix structure, when both the horizontal and vertical switches are turned on, the charge of the photodiode at the position corresponding to these switches is directly connected to the output amplifier, converted into a voltage, and output as a voltage signal. Note that a charge can be stored only in the photodiode, so the rolling shutter scheme in which sensor information is sequentially output for each horizontal line is adopted. As a special case, a CMOS sensor which adopts the global shutter scheme upon being additionally equipped with a memory function is available, but is expensive due to its complex internal configuration and large circuit scale. Therefore, a rolling shutter CMOS sensor is commonly used in that case.

However, the rolling shutter scheme cannot capture an image by full-field simultaneous exposure, and therefore use respective lines in different states at the same time instant. This makes it very difficult to use the rolling shutter scheme in image capture for measurement.

The upper part of FIG. 2B shows the relationship among a variation in image capture start time of each line, the exposure time on one horizontal line, the transfer time, allocation of the horizontal blanking time, and the vertical blanking time. The ordinate indicates the image capture position represented by the line number, and signal lines are scanned in the top-to-bottom direction as the sub-scanning direction (vertical direction). The abscissa indicates a time corresponding to the periods of two frames.

As can be seen from FIG. 2B, the variation in image capture start time of each horizontal line corresponds to the sum of the transfer time and horizontal blanking time on one horizontal line. This time variation is the time difference of the start of projection from an adjacent line for each line. In other words, in the rolling shutter scheme, the exposure time of each horizontal line must be maintained constant to maintain the exposure time of one frame constant, but the transfer process of the succeeding horizontal line can be started only after the transfer process of the preceding horizontal line is completed, because a transfer process is performed for each horizontal line. Hence, the time taken for the transfer process and horizontal blanking process of the preceding horizontal line is calculated in advance, and the exposure process of the succeeding horizontal line is started the calculated time after the start of exposure of the preceding horizontal line, thereby maintaining the exposure time of each horizontal line constant.

For this reason, the exposure time, transfer time, and horizontal blanking time on one horizontal line are the same in all horizontal lines, but the image capture start time varies in each individual line, so the time elapsed from the start of exposure of each horizontal line varies depending on the image capture position at the same time instant, and one of the exposure state, the transfer state, and the horizontal blanking state may mix with another state. An image capture device has such image capture characteristics. The lower part of FIG. 2B shows the outline of the operation of each line on the upper part of FIG. 2B.

For three dimensional measurement using a projection device and image capture device having such image capture characteristics, it is necessary to ensure a sufficient period in which the projection luminance is constant on the projection side, and to use a plurality of frames so as to ensure a time sufficient to complete image capture on the image capture side during the period in which the projection luminance is constant.

In this embodiment, the synchronization control unit 104 more accurately, appropriately adjusts the synchronization timing between projection and image capture to attain high-speed measurement for each frame.

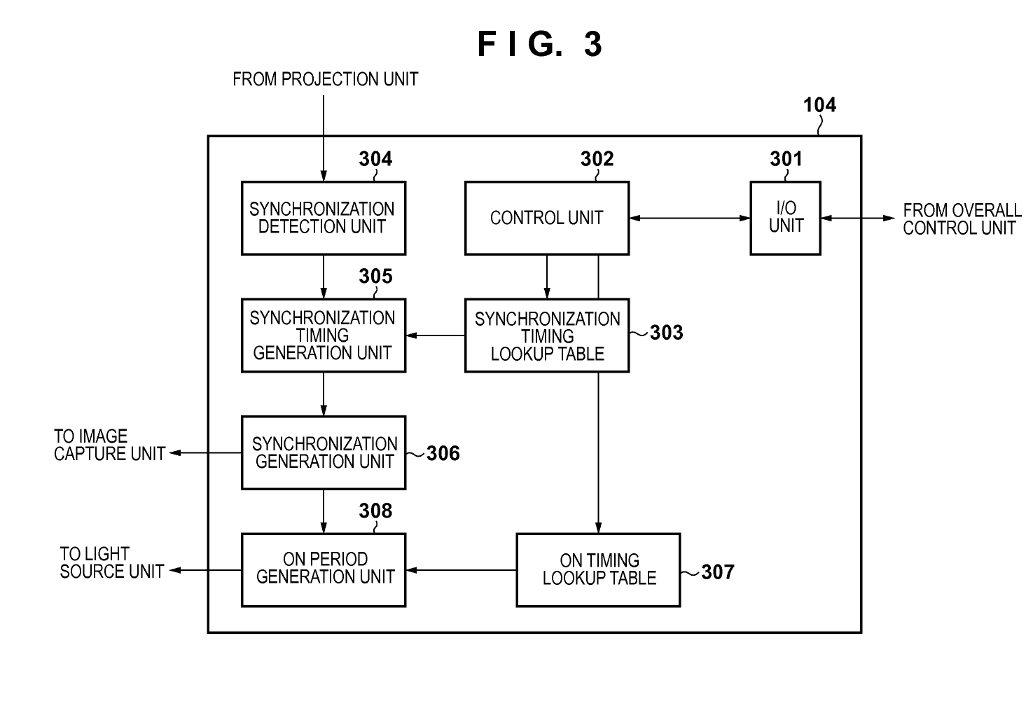

FIG. 3 is a block diagram showing the internal configuration of the synchronization control unit 104. The synchronization control unit 104 includes an I/O unit 301, control unit 302, synchronization timing lookup table 303, synchronization detection unit 304, synchronization timing generation unit 305, synchronization generation unit 306, ON timing lookup table 307, and ON period generation unit 308.

The I/O unit 301 receives light source ON information and synchronization timing information for synchronization between the projection timing and the image capture timing from the overall control unit 101.

The control unit 302 stores the synchronization timing information received by the I/O unit 301 in the synchronization timing lookup table 303, and stores the light source ON information received by the I/O unit 301 in the ON timing lookup table 307.

The synchronization detection unit 304 receives a signal associated with synchronization from the projection unit 102, and detects a synchronization signal (more specifically, a signal Vsync) required for synchronization.

The synchronization timing generation unit 305 outputs a synchronization timing signal serving as a synchronization generate command to the synchronization generation unit 306 when the timing to generate a synchronization signal comes, based on the synchronization timing information read out from the synchronization timing lookup table 303 for the synchronization signal detected by the synchronization detection unit 304. In response to the synchronization timing signal, the synchronization generation unit 306 generates a synchronization signal that can be recognized as an external trigger signal by the image capture unit 103, and sends it to the image capture unit 103.

The ON period generation unit 308 generates an ON signal from the ON timing information, read out from the ON timing lookup table 307, using the synchronization timing signal generated by the synchronization timing generation unit 305, and outputs it to the light source unit 102-1 of the projection unit 102.

In this manner, both the image capture timing of the image capture unit 103 and the ON timing of the light source unit 102-1 of the projection unit 102 can be controlled in synchronism with the projection timing of the projection unit 102.

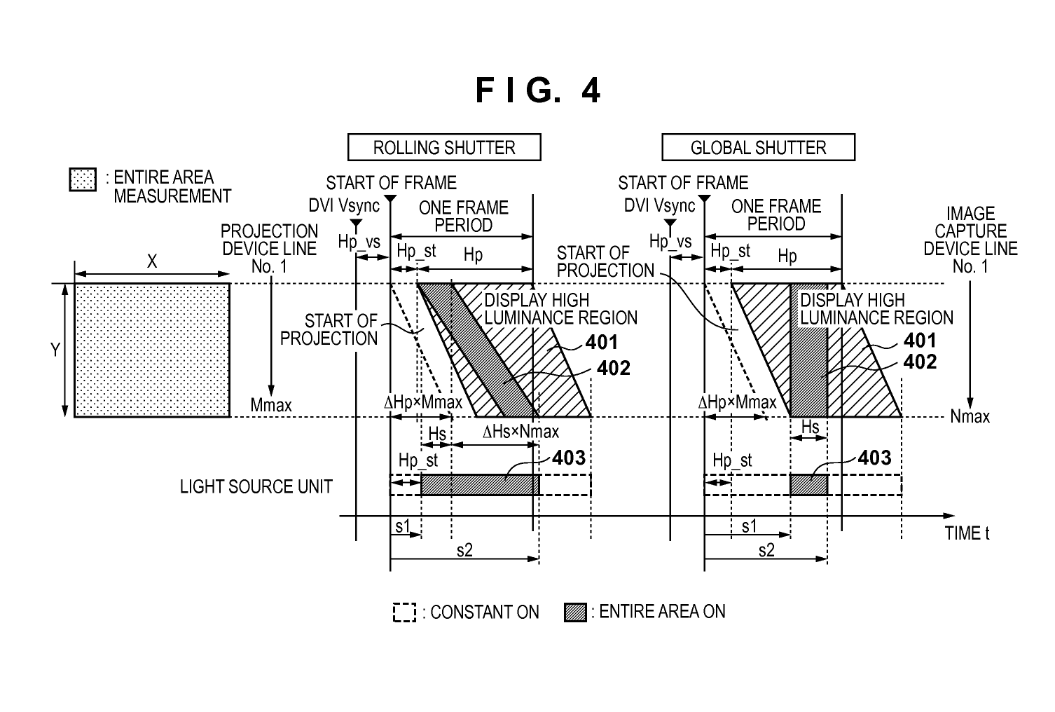

FIG. 4 exemplifies the case wherein the entire area is measured at the synchronization timing between projection and image capture in the first embodiment. Referring to FIG. 4, the operation timings of projection and image capture, which are the outlines of FIGS. 2A and 2B, are controlled in synchronism with each other to merge these timings together.

Referring to FIG. 4, a parallelogram 401 indicates the projection timing, and a parallelogram 402 indicates the image capture timing. When the parallelogram 402 indicating the image capture timing falls within the parallelogram 401 indicating the projection timing, this means that the image capture timing can be adjusted appropriately for the projection timing.

Note that the left part of FIG. 4 shows the synchronization timing between the projection timing in the line-sequential driving scheme and the image capture timing in the rolling shutter scheme. On the other hand, the right part of FIG. 4 shows the synchronization timing between the projection timing in the line-sequential driving scheme and the image capture timing in the global shutter scheme. Each of the lower left and lower right parts of FIG. 4 shows the ON timing of the light source unit.

A duration s1 is the start time of effective pattern projection delayed due to factors associated with the line-sequential driving scheme and the rise characteristics of the display device of the projection unit 102, and a duration s2 is the end time of image capture. The duration obtained by subtracting the duration s1 from the duration s2 is an ON period 403 of the light source unit.

A method of calculating a timing which allows efficient, high-speed projection and image capture by synchronizing the projection operation and the image capture operation in order to set a minimum ON period 403 will be described below.

First, to accurately measure the edge position of the projection pattern, it is necessary to set the resolution of the image capture unit 103 higher than that of the projection unit 102. When the resolution of the image capture unit 103 is p times that of the projection unit 102,

the number of horizontal pixels m of the image capture unit 103 and the number of horizontal pixels n of the projection unit 102 have a relation given by:

n=m×p, and

the number of vertical lines N of the image capture unit 103 and the number of vertical lines M of the projection unit 102 have a relation given by:

N=M×p(L+N=M×p in ROI control, where L is the start line of ROI control)

Although the projection unit 102 can adopt the frame-sequential driving scheme or the line-sequential scheme as its display scheme, the following description assumes a line-sequential driving liquid crystal device, timing adjustment of which is difficult.

As performance characteristic information unique to the display device, the offset time (to be symbolized by “Hp_st” hereinafter) until projection for each line becomes effective is used. The offset time is the time taken for the display device to become a projection state in which measurement is possible after the start of projection, and depends on the response property of rise of the display device.

As another performance characteristic information unique to the display device, the time variation (to be symbolized as “ΔHp hereinafter) for each line is used. In the line-sequential driving scheme, a predetermined variation in projection start time occurs in each individual line, and the degree of variation is determined depending on the active matrix driving scheme of the liquid crystal projector, and the circuit configuration of, for example, a line buffer.

As still another performance characteristic information unique to the display device, the effective projection time (to be symbolized as “Hp” hereinafter) for each line is used. The effective projection time is, for example, the period in which the brightness is 80% or more when the projection pattern is a white pattern, or that in which the brightness is 20% or less when the projection pattern is a black pattern, and depends on the response property of the display device. Based on these pieces of performance characteristic information unique to the display device,

the time variation of the Mth line of the projection unit 102 can be calculated as:

ΔHp×M

the effective projection start time of the Mth line of the projection unit 102 can be calculated as:

Hp_{—}st+ΔHp×M, and

the effective projection end time of the Mth line of the projection unit 102 can be calculated as:

Hp_{—}st+ΔHp×M+Hp

Although the image capture unit 103 can adopt the global shutter scheme or the rolling shutter scheme as its image capture scheme, the following description assumes a rolling shutter CMOS image capture device, timing adjustment of which is difficult.

As performance characteristic information unique to the rolling shutter image capture device, the pixel speed (to be symbolized as “f” hereinafter), for example, is used. The pixel speed f is the speed at which sensor information is output from the image sensor.

As another performance characteristic information unique to the rolling shutter image capture device, the time variation (to be symbolized as “ΔHs” hereinafter) for each line is used. The time variation ΔHs is the time (including the blanking period) taken for sensor information of one horizontal line to be transferred to an external device.

Pieces of performance characteristic information including the number of horizontal pixels n for each line, the horizontal blanking count (to be symbolized as “bk” hereinafter) for each line, and the exposure time for each line are parameters that can be freely changed and set by the operator within the tolerance of the image capture unit 103. Based on these parameters, the time variation ΔHs for each line can be calculated as ΔHs=(n+bk)×f, and the process time for each line can be calculated as Hs+ΔHs.

The case wherein the image capture unit 103 performs partial image capture by ROI control will be considered. The offset time (to be symbolized as “ROI_st” hereinafter) of the ROI control start line L is added as a parameter that can arbitrarily be set and changed. To start image capture by ROI control, projection must be started before the start of image capture on a projection line corresponding to a position identical to the start line position of ROI control. This means that the offset time ROI_st of the ROI control start line L depends on factors associated with the projection side. Hence, from the effective projection start time of the Mth line on the projection side (Hp_st+ΔHp×M), the number of vertical lines (M=N/p), and N=L, we have ROI_st=Hp_st+ΔHp×(L/P). Based on this relation,

the time variation of the Nth line of the image capture unit 103 (addition of the offset time ROI_st of the ROI control start line L) can be calculated as:

ROI_{—}st+ΔHs×N [symbol] {Hp_{—}st+ΔHp×(L/p)}+ΔHs×N

the image capture start time of the Nth line of the image capture unit 103 (addition of the offset time ROI_st of the ROI control start line L) can be calculated as:

ROI_{—}st+ΔHs×N [symbol] {Hp_{—}st+ΔHp×(L/p)}+ΔHs×N, and

the image capture end time of the Nth line of the image capture unit 103 (addition of the offset time ROI_st of the ROI control start line L) can be calculated as:

ROI_{—}st+ΔHs×N+Hs [symbol] {Hp_{—}st+ΔHp×(L/p)}+ΔHs×N+Hs

Using the projection time information of the projection unit 102, and the image capture time information of the image capture unit 103, the conditions in which the projection and image capture timings are appropriately adjusted and controlled are set as follows. To perform exposure of the image capture unit 103 within the effective projection period of the projection unit 102, it is necessary to satisfy the following two conditions.

First, as condition 1, it is necessary to start the exposure operation of the image capture unit 103 after the effective projection start time of the projection unit 102. This means that the exposure start time of the image capture unit 103 must be set to be after the effective projection start time of the projection unit 102. That is, it is necessary to satisfy relations:

(the image capture start time of the Nth line)≧(the effective projection start time of the Mth line)

[symbol]

ROI_{—}st+ΔHs×N≧Hp_{—}st+ΔHp×{(L+N)/p} for M=(L+N)/p

[symbol]

{Hp_{—}st+ΔHp×(L/p)}+ΔHs×N≧Hp_{—}st+ΔHp×((L+N)/p)

[symbol]

ΔHs×N−ΔHp×(N/p)≧Hp_{—}st+ΔHp×(L/p)−Hp_{—}st−ΔHp×(L/p)

[symbol]

N≧0

Next, as condition 2, it is necessary to end the exposure operation of the image capture unit 103 before the effective projection end time of the projection unit 102. This means that the exposure end time of the image capture unit 103 must be set to be the same as or earlier than the effective projection end time of the projection unit 102. That is, it is necessary to satisfy relations:

(the image capture end time of the Nth line)≧(the effective projection end time of the Mth line)

[symbol]

ROI_{—}st+ΔHs×N+Hs≦Hp_{—}st+ΔHp×M+Hp

[symbol]

{Hp_{—}st+ΔHp×(L/p)}+ΔHs×N+Hs≦Hp_{—}st+ΔHp×((L+N)/p)+Hp for M=(L+N)/p

[symbol]

Hp_{—}st+ΔHp×(L/p)+ΔHs×N+Hs≦Hp_{—}st+ΔHp×((L+N)/p)+Hp

[symbol]

N≦(Hp−Hs)/(ΔHs−ΔHp/p)

[symbol]

N≦(Hp−Hs)/((n+bk)×f−ΔHp/p) for ΔHs=(n+bk)×f

As can be seen from the above-mentioned relations, to satisfy both conditions 1 and 2, it is necessary to satisfy a relation:

(Hp−Hs)/((n+bk)×f−ΔHp/p)≧N≧0 (1)

Relation (1) indicates that the time obtained by subtracting the exposure time Hs of the image capture unit 103 from the effective projection time Hp of the projection unit 102 for each line is the moratorium period in which the difference in time generated between projection scanning and image capture scanning within one frame period can be absorbed, and the value obtained by dividing this moratorium period by the difference in time for each line generated between projection scanning and image capture scanning becomes the maximum number of vertical lines Nₘₐₓ of image capture.

Note that Hp, f, and ΔHp/p are constants, while n, bk, Hs, and N are setting parameters, so the number of horizontal pixels n of image capture, the blanking count bk, the exposure time Hs of the image capture unit 103, and the number of vertical lines N of image capture in the ROI control area are determined so as to satisfy the condition presented in relation (1), thereby appropriately adjusting the projection and image capture timings.

By setting the ROI control start line L, the image capture start time s1 can be calculated as:

s1=Hp_{—}st+ΔHp×(L/p) for M=L

Then, by setting the number of horizontal pixels n, the blanking count bk, and the number of vertical lines N in the ROI control area so as to satisfy relation (1), the image capture end time s2 can be calculated as:

$$\begin{matrix}\begin{matrix}s 2 = s 1 + Δ Hs \times N \\ = \{ Hp\_st + Δ Hp \times ( L / p ) \} + \{ ( n + bk ) \times f \} \times N\end{matrix} & \\ for Δ Hs = ( n + bk ) \times f & \end{matrix}$$

Although the case wherein the image capture unit 103 performs ROI control and image capture has been described above, two cases wherein the image capture unit 103 does not perform ROI control are assumed as follows:

case 1 wherein image capture of the entire field starts simultaneously with the start of projection without ROI control, and

case 2 wherein image capture of the entire field starts with a delay corresponding to the offset value Hs_st from the start of projection without ROI control.

In each of cases 1 and 2, as in the case wherein ROI control is performed,

the time variation of the Nth line of the image capture unit 103 can be calculated as:

ΔHs×N (case 1)

Hs_{—}st+ΔHs×N (case 2)

the image capture start time of the Nth line of the image capture unit 103 can be calculated as:

ΔHs×N (case 1)

Hs_{—}st+ΔHs×N, and (case 2)

the image capture end time of the Nth line of the image capture unit 103 can be calculated as:

ΔHs×N+Hs (case 1)

Hs_{—}st+ΔHs×N+Hs (case 2)

These parameters are similarly applied to conditions 1 and 2. First, as condition 1, it is necessary to start the exposure operation of the image capture unit 103 after the effective projection start time of the projection unit 102. This means that the exposure start time of the image capture unit 103 must be set to be after the effective projection start time of the projection unit 102. That is, it is necessary to satisfy relations:

(the image capture start time of the Nth line)≧(the effective projection start time of the Mth line)

[symbol]

ΔHs×N≧Hp_{—}st+ΔHp×(N/p)

[symbol]

N≧Hp_{—}st/((n+bk)×f−ΔHp/p) for ΔHs=(n+bk)×f (case 1)

[symbol]

Hs_{—}st+ΔHs×N≧Hp_{—}st+ΔHp×(N/p)

[symbol]

N≧(Hp_{—}st−Hs_{—}st)/((n+bk)×f−ΔHp/p) for ΔHs=(n+bk)×f (case 2)

Next, as condition 2, it is necessary to end the exposure operation of the image capture unit 103 before the effective projection end time of the projection unit 102. This means that the exposure end time of the image capture unit 103 must be set to be the same as or earlier than the effective projection end time of the projection unit 102. That is, it is necessary to satisfy relations:

(the image capture end time of the Nth line)≧(the effective projection end time of the Mth line)

[symbol]

ΔHs×N+Hs≦Hp_{—}st+ΔHp×(N/p)+Hp

[symbol]

N≦(Hp_{—}st+Hp−Hs)/((n+bk)×f−ΔHp/p) for ΔHs=(n+bk)×f (case 1)

Hs_{—}st+ΔHs×N+Hs≦Hp_{—}st+ΔHp×(N/p)+Hp

[symbol]

N≦(Hp_{—}st+Hp−Hs_{—}st−Hs)/((n+bk)×f−ΔHp/p) for ΔHs=(n+bk)×f (case 2)

As can be seen from the above-mentioned relations, to satisfy both conditions 1 and 2, it is necessary to satisfy relations:

(case 1)

(Hp_{—}st+Hp−Hs)/((n+bk)×f−ΔHp/p)≧N≧Hp_{—}st/((n+bk)×f−ΔHp/p) for N≧0 (2)

(case 2)

(Hp_{—}st+Hp−Hs_{—}st−Hs)/((n+bk)×f−ΔHp/p)≧N≧(Hp_{—}st−Hs_{—}st)/((n+bk)×f−ΔHp/p) for N≧0 (3)

This means that in case 1, the time obtained by subtracting the exposure time Hs of the image capture unit 103 from the effective projection time Hp of the projection unit 102, and adding the projection start offset value Hp_st from the difference is the moratorium period in which the difference in time generated between projection scanning and image capture scanning within one frame period can be absorbed, and the value obtained by dividing this moratorium period by the difference in time for each line generated between projection scanning and image capture scanning becomes the maximum number of vertical lines of image capture, which satisfies relation (2). Hence, an image capture area defined up to this number of vertical lines can be captured. In addition, the projection start offset time Hp_st is the period in which the image capture unit 103 stands by for image capture using the difference in time generated between projection scanning and image capture scanning within one frame period, and the value obtained by dividing this period by the difference in time for each line generated between projection scanning and image capture scanning becomes the minimum number of vertical lines of image capture, which satisfies relation (2). Hence, an image capture area defined from this number of vertical lines can be captured. That is, from the above-mentioned two conditions, relation (2) indicates that an image capture area defined from the minimum number of vertical lines to the maximum number of vertical lines is effective.

On the other hand, in case 2, the time obtained by adding the difference obtained by subtracting the exposure time Hs of the image capture unit 103 from the effective projection time Hp of the projection unit 102, and the difference obtained by subtracting the image capture start offset time Hs_st from the projection start offset time Hp_st is the moratorium period in which the difference in time generated between projection scanning and image capture scanning within one frame period can be absorbed, and the value obtained by dividing this moratorium period by the difference in time for each line generated between projection scanning and image capture scanning becomes the maximum number of vertical lines of image capture, which satisfies relation (3). Hence, an image capture area defined up to this number of vertical lines can be captured. In addition, the projection start offset time Hp_st is the period in which the image capture unit 103 stands by for image capture using the difference in time generated between projection scanning and image capture scanning within one frame period, and the value obtained by dividing this period by the difference in time for each line generated between projection scanning and image capture scanning becomes the minimum number of vertical lines of image capture, which satisfies relation (3). Hence, an image capture area defined from this number of vertical lines can be captured. That is, from the above-mentioned two cases, relation (3) indicates that an image capture area defined from the minimum number of vertical lines to the maximum number of vertical lines is effective.

Note that Hp, f, and ΔHp/p are constants, while n, bk, Hs, N, and Hs_st are setting parameters, so the number of horizontal pixels n of image capture, the blanking count bk, the exposure time Hs of image capture, the number of vertical lines N of image capture in the ROI control area, and the offset value Hs_st from the start of projection are determined so as to satisfy the condition presented in relation (2) or (3), thereby appropriately adjusting the projection and image capture timings.

The image capture start time s1 and image capture end time s2 can be calculated as:

s1=Hp_{—}st

s2=Hp_{—}st+(n+bk)×f×N+Hs (case 1)

s1=Hs_{—}st

s2=Hp_{—}st+(n+bk)×f×N+Hs (case 2)

With the above-mentioned operation, the image capture parameters determined in the above-mentioned way are set for the image capture unit 103, and the image capture start timing of the synchronization control unit 104 is set to the value calculated in the above-mentioned way. Then, the synchronization control unit 104 outputs an external trigger signal to the image capture unit 103 with a delay corresponding to the set value relative to a projection synchronization signal, and the image capture unit 103 captures an image in synchronism with the output trigger signal. This allows projection and image capture for each frame and, in turn, low-cost, high-speed three dimensional measurement even for a combination of a line-sequential driving projection unit 102 and a rolling shutter image capture unit 103.

Case 1 corresponds to a combination of display of a line-sequential driving projection unit 102 and a rolling shutter image capture unit 103 in the left part of FIG. 4. However, case 2 corresponds to a combination of display of a frame-sequential driving projection unit 102 and a rolling shutter image capture unit 103. Note that in a combination of display of a line-sequential driving projection unit 102 and a global shutter image capture unit 103 in the right part of FIG. 4, synchronization adjustment is done so that an image is captured during the period in which the entire field is displayed at once using the line-sequential driving scheme (the period from the start of display of the last line until the end of display of the first line). Synchronization between display of the frame-sequential driving scheme and image capture of the global shutter scheme can easily be adjusted because an image need only be captured during the display period.

As described above, according to this embodiment, a variable ON/OFF light source is used as the light source of the projection unit to synchronize the projection unit and the image capture unit based on, for example, the time variation between the projection unit and the image capture unit for each line, the response property of the display device, the image capture area information (the ROI size and position), and the projection pattern. Also, the light source is kept ON only during the period required for measurement, thereby constructing a three dimensional measurement apparatus including a projection unit excellent in terms of the use efficiency of the light source. Moreover, the ON time of the light source is shortened to prevent an increase in temperature of the light source, thereby allowing life prolongation and power saving of the light source.

### Second Embodiment

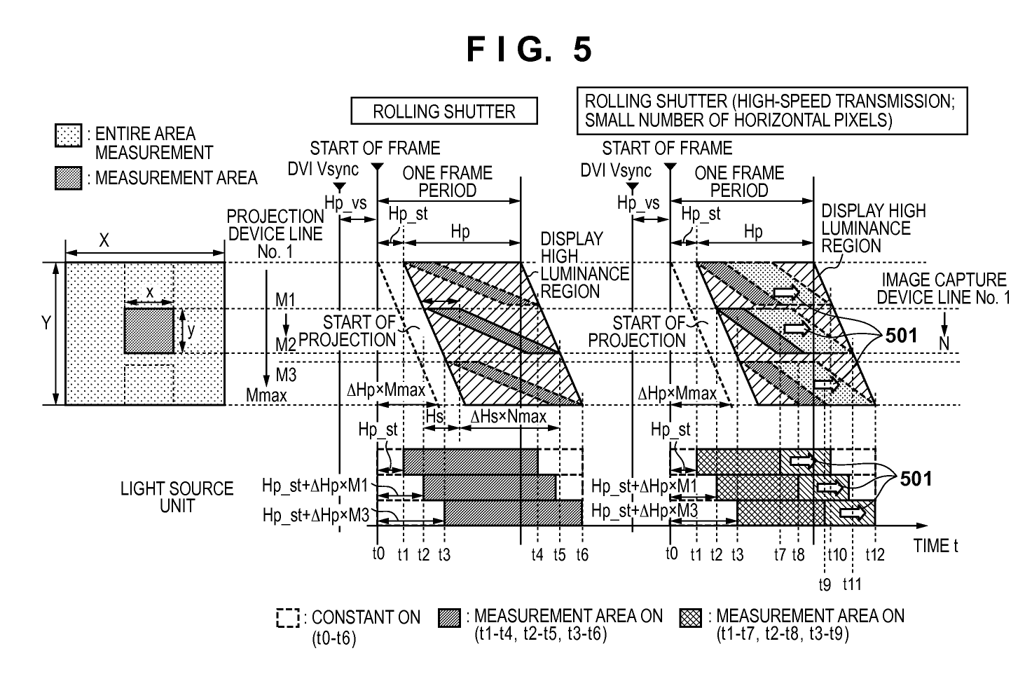

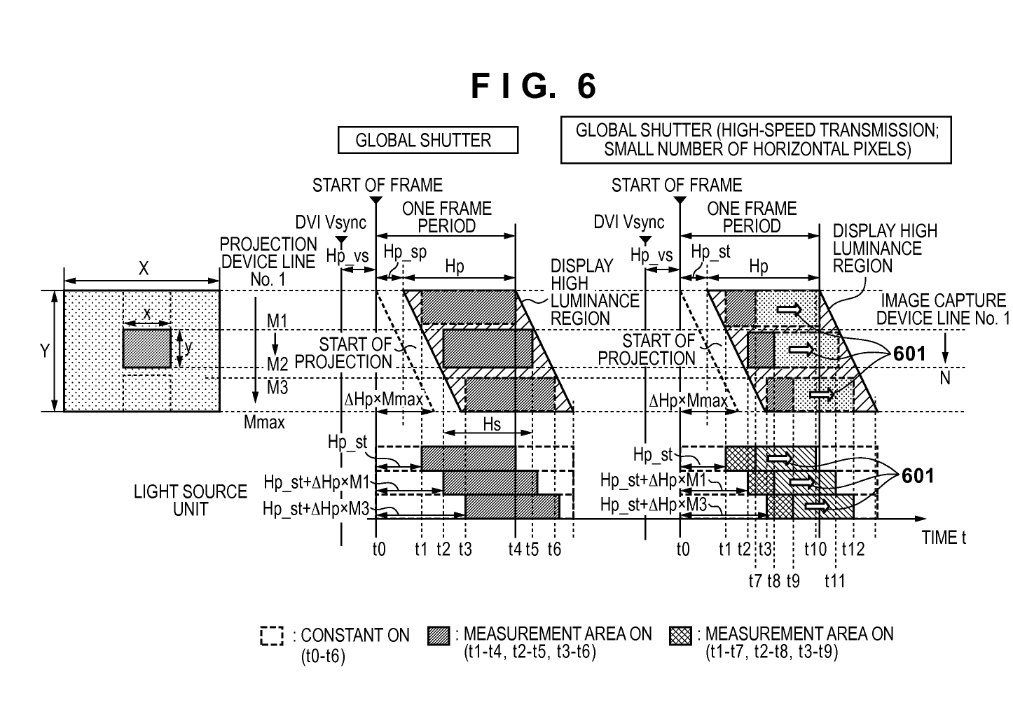

The synchronization timing between projection and image capture when a partial area of the entire area is measured in the second embodiment will be described with reference to FIGS. 5 and 6. Partial image capture as in this case will be referred to as ROI image capture hereinafter.

Note that FIG. 5 shows ROI image capture of the rolling shutter scheme, in which an image is captured upon division of an ROI into three regions: the upper, middle, and lower regions on the vertical line. In this case, the ON period of the light source unit varies depending on the position in the ROI. The light source unit is turned on early in the upper region, and is turned on later from the middle region to the lower region. The image capture start time s1 corresponds to t1 for the upper region, t2 for the middle region, and t3 for the lower region. Also, the image capture end time s2 corresponds to t4 for the upper region, t5 for the middle region, and t6 for the lower region.

The right part of FIG. 5 assumes an image capture system that operates at a speed higher than that of an image capture system shown in the left part of FIG. 5. In this case, as the image capture period shortens, the ON period can also be shortened, and the exposure time can be prolonged, as indicated by an arrows 501, if the same ON period as in the left part of FIG. 5 is set.

On the other hand, FIG. 6 shows ROI image capture of the global shutter scheme, in which an image is captured upon division of an ROI into three regions: the upper, middle, and lower regions on the vertical line, like FIG. 5. In this case, the ON period of the light source unit varies depending on the position in the ROI. The light source unit is turned on early in the upper region, and is turned on later from the middle region to the lower region. The image capture start time s1 corresponds to t1 for the upper region, t2 for the middle region, and t3 for the lower region. Also, the image capture end time s2 corresponds to t4 for the upper region, t5 for the middle region, and t6 for the lower region.

The right part of FIG. 6 assumes an image capture system that operates at a speed higher than that of an image capture system shown in the left part of FIG. 6. In this case, as the image capture period shortens, the ON period can also be shortened, and the exposure time can be prolonged, as indicated by an arrows 601, if the same ON period as in the left part of FIG. 6 is set.

### Third Embodiment

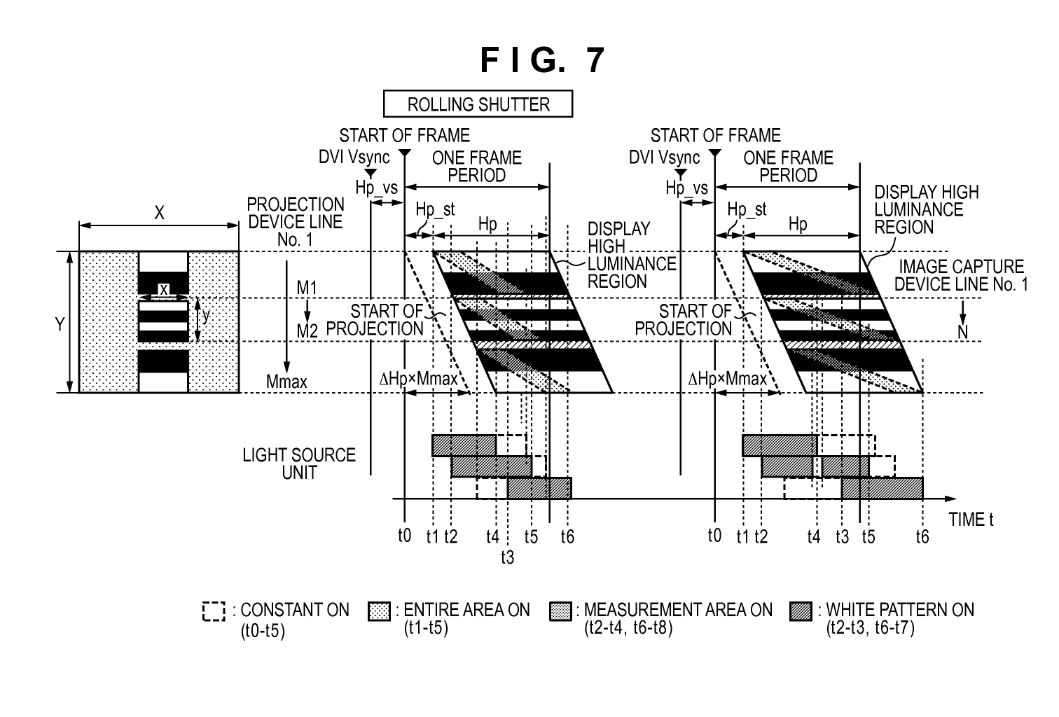

The synchronization timing between projection and image capture when a light source is kept ON only during the period corresponding to the white portion (high luminance portion) of the projection pattern in the third embodiment will be described with reference to FIG. 7. In an example shown in FIG. 7, using a combination of display of a line-sequential driving projection unit 102 and a rolling shutter image capture unit 103, ROI image capture is performed by projecting a white-black pattern in the upper region, a white-black-white-black pattern in the middle region, and a black-white pattern in the lower region on the vertical lines.

As in the cases of FIGS. 5 and 6, ON periods as long as those indicated by dotted frames are necessary in terms of the ROI alone. However, in the case of FIG. 7, in the upper region of the vertical line, the light source is kept ON only during the first half period in which the white pattern is used, and is kept OFF during the second half period in which the black pattern is used. In the middle region, the light source is kept OFF during the period in which the lower black pattern of the white-black-white-black pattern is used. In the lower region, the light source is kept OFF for the first half period in which the black pattern is used, and is kept ON only during the second half period in which the white pattern is used. This makes it possible to set a minimum required ON period.

The right part of FIG. 7 shows the case wherein the exposure period can be shortened more by image capture of the rolling shutter scheme. For example, in the middle region, a period in which the black region sandwiched between the white regions in the white-black-white-black pattern occurs, so the light source can further be kept ON during this period.

### Fourth Embodiment

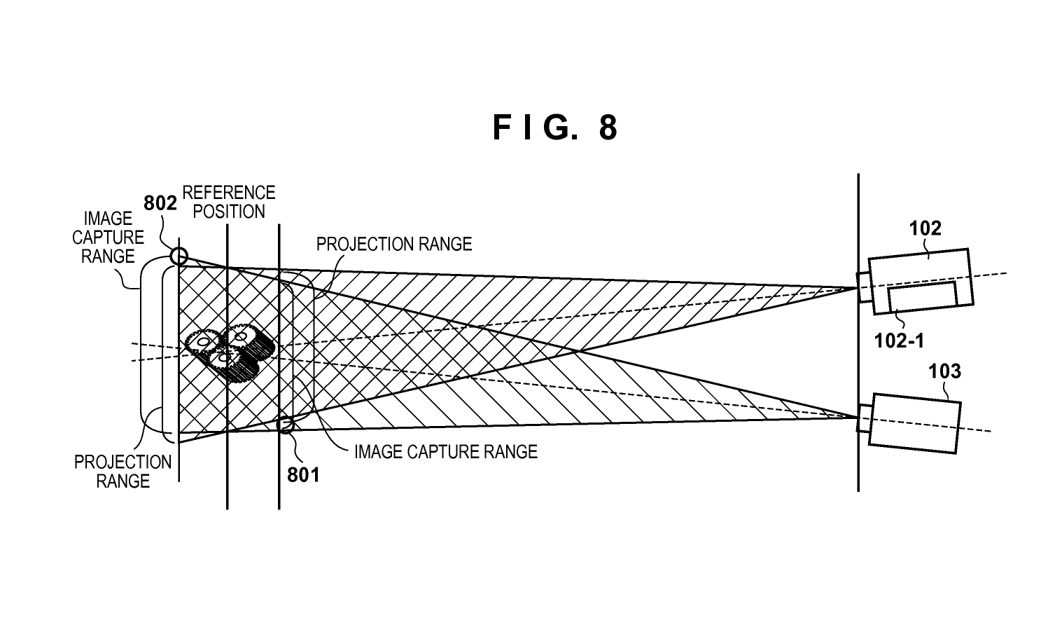

The synchronization timing between projection and image capture when the ON period is set longer than the image capture period will be described in this embodiment. The reason why the ON period is set longer than the image capture period will be explained first with reference to FIG. 8.

First, in measuring a target object having a given depth in three dimensional measurement, projection and image capture of the measurement distance are performed at positions shifted to the front or rear from a reference position within the measurement tolerance in the depth direction. In this case, even if the projection area coincides with the image capture area at the reference position, the projection area shifts to the projection side and narrows at a position more to the front than the reference position, so an area 801 to which the projection pattern is not projected is partially generated in the image capture area on the image capture side at that position. In contrast to this, the projection area shifts to the projection side and widens at a position more to the back than the reference position, but an area 802 to which the projection pattern is not projected is partially generated in the image capture area on the image capture side at that position. For this reason, it is necessary to set the ON period longer than the image capture period so as to allow measurement by projection to the area 802.

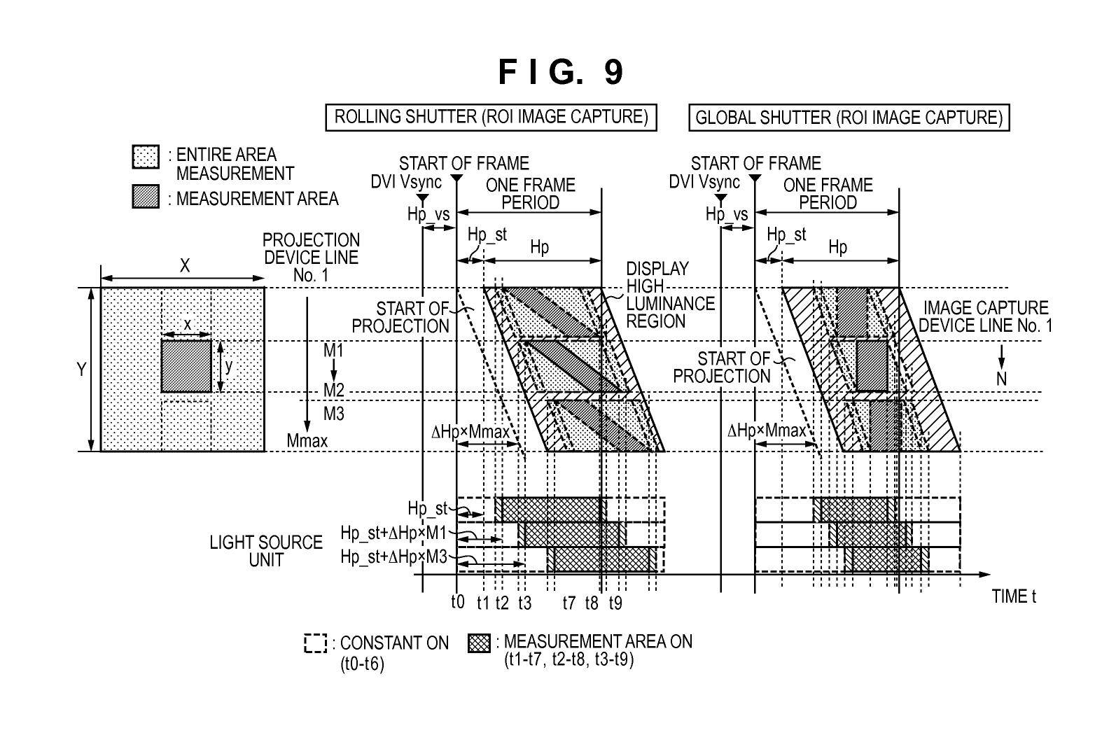

The synchronization timing between projection and image capture when the ON period is set longer than the image capture period in the fourth embodiment will be described with reference to FIG. 9. Referring to FIG. 9, the ON period is set such that the light source is kept ON not only during the image capture period but also during the period of extension of the image capture period forwards or backwards. The number of horizontal pixels and the number of vertical lines in an area, which does not overlap the projection area, of the image capture area are calculated (area calculation process). As the number of lines corresponding to the period of extension of the image capture period, the number of image capture lines in the area 802 to which the projection pattern is not projected is added to the number of ROI lines, and the ON period is set to the period corresponding to the total number of lines.

### Fifth Embodiment

A configuration which obtains the characteristic information of a projection unit and image capture unit to generate a synchronization timing between projection and image capture will be described in this embodiment.

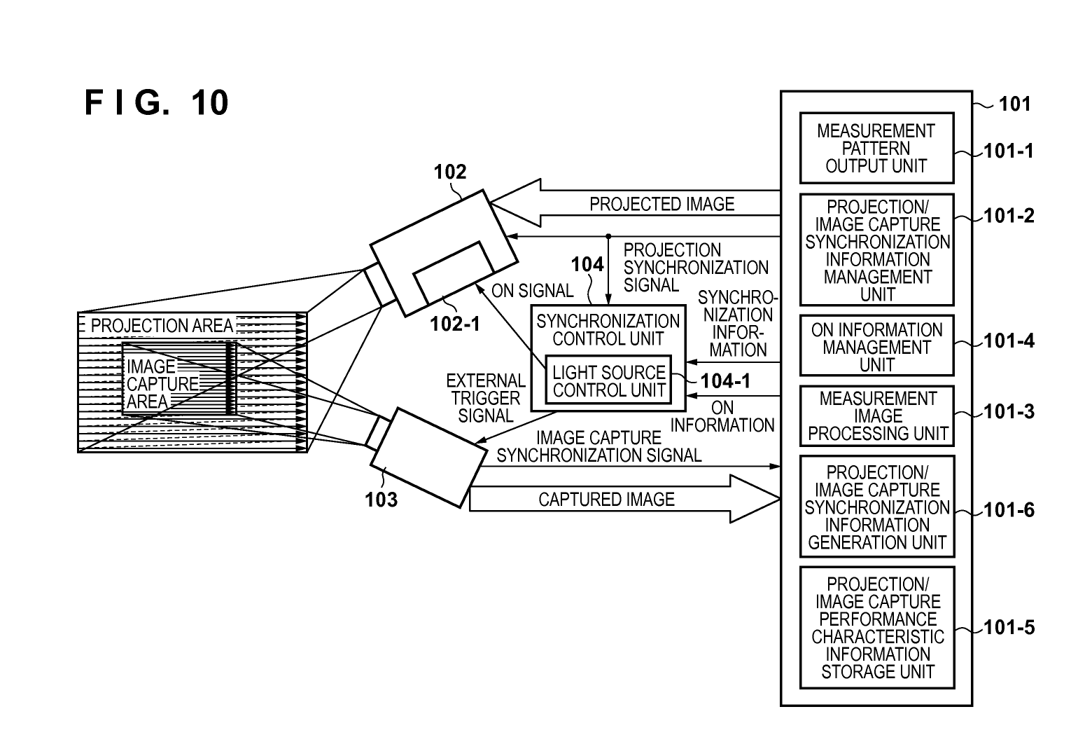

The configuration of a three dimensional measurement apparatus in the fifth embodiment will be described with reference to FIG. 10. The three dimensional measurement apparatus in this embodiment has a configuration different from that of the three dimensional measurement apparatus in the first embodiment in that in the former an overall control unit 101 further includes a projection/image capture performance characteristic information storage unit 101-5 and projection/image capture synchronization information generation unit 101-6.

The projection/image capture performance characteristic information storage unit 101-5 stores the performance characteristic information of the projection unit and image capture unit in advance. The projection/image capture synchronization information generation unit 101-6 is configured to read out required performance characteristic information from the projection/image capture performance characteristic information storage unit 101-5, generate synchronization information from the readout performance characteristic information using the calculation method described in the first embodiment, and output the synchronization information to a synchronization control unit 104 as needed.

Therefore, when the specification of either the projection unit or the image capture unit is changed, the performance characteristic information of the changed part is newly input to and stored in the projection/image capture performance characteristic information storage unit 101-5, thereby automatically generating a synchronization timing based on the stored performance characteristic information. This makes it possible to easily cope with a change in specification of either the projection unit or the image capture unit.

### Sixth Embodiment

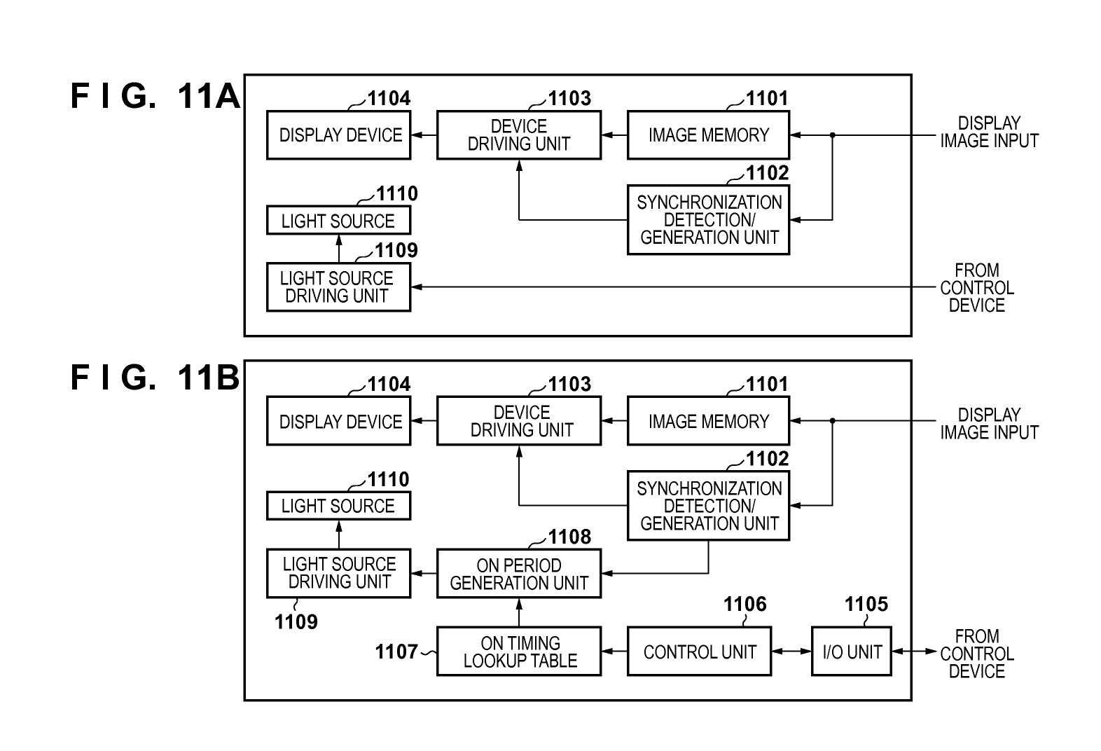

The internal configuration of a light source unit 102-1 of a light source unit 102-1 will be described with reference to FIGS. 11A and 11B. The configuration of the light source unit 102-1 shown in FIG. 11A corresponds to the first embodiment. The light source unit 102-1 includes an image memory 1101, synchronization detection/generation unit 1102, device driving unit 1103, display device 1104, light source driving unit 1109, and light source 1110. The image memory 1101 stores image data to be displayed on the display device 1104. The synchronization detection/generation unit 1102 obtains synchronization information and operates the device driving unit 1103 in accordance with the synchronization information. The device driving unit 1103 drives the display device 1104. The light source driving unit 1109 drives the light source 1110.

The light source unit 102-1 shown in FIG. 11B includes an I/O unit 1105, control unit 1106, ON timing lookup table 1107, and ON period generation unit 1108, in addition to the constituent units shown in FIG. 11A. The I/O unit 1105, that is, input/output unit 1105 exchanges information with an external device. The control unit 1106 stores, in the ON timing lookup table 1107, ON timing information transferred from an external device via the I/O unit 1105. The ON period generation unit 1108 operates the light source driving unit 1109 in accordance with the pieces of information obtained from the synchronization detection/generation unit 1102 and ON timing lookup table 1107.

In the case of FIG. 11B, unlike the case of FIG. 11A, the ON timing information of the light source 1110 is transferred from an external device to the light source unit 102-1 in advance, and expanded into the ON timing lookup table 1107, thereby keeping the light source 1110 ON during the ON period and the period corresponding to an offset value set for the display timing of the display device 1104 in advance. In both cases, ON/OFF of the light source 1110 can externally be controlled.

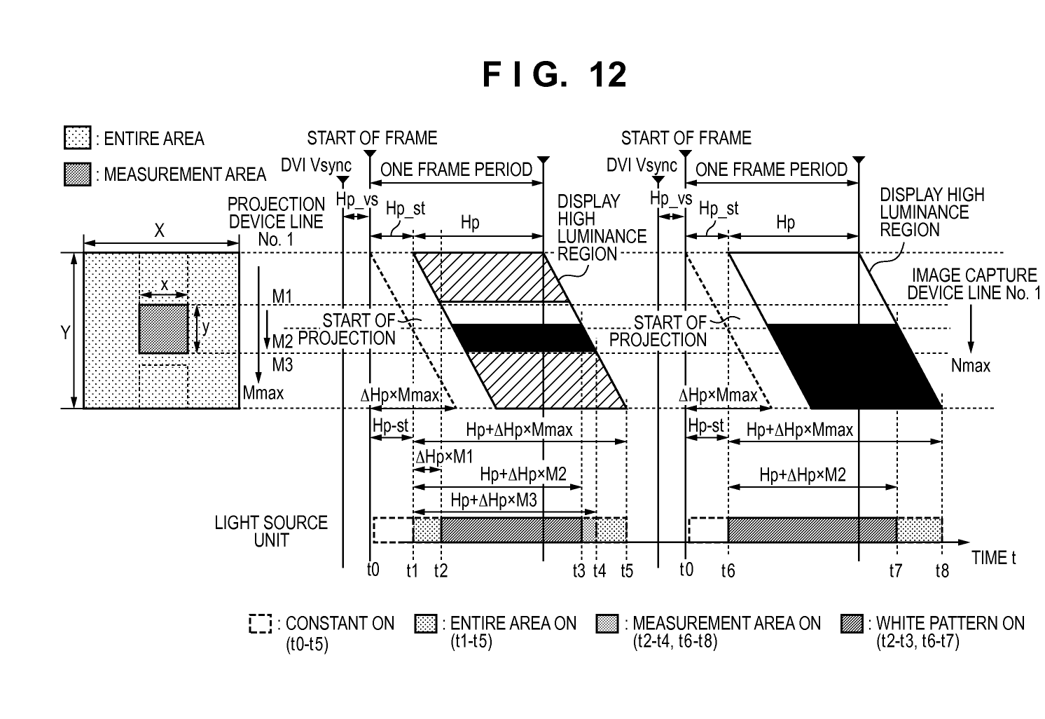

FIG. 12 is a timing chart showing the projection and light source ON timings of the projection device shown in each of FIGS. 11A and 11B. FIG. 12 shows the case wherein the light source is kept ON in the entire area, that wherein the light source is kept ON in a partial measurement area, and that wherein the light source is kept ON only in the white portion (high luminance region) of the projection pattern. The left part of FIG. 12 shows the case wherein a white-black pattern is projected to the measurement area, and the right part of FIG. 12 shows the case wherein a white-black pattern is projected to the entire area. The light source unit need only be kept ON from t2 to t3 and from t6 to t7, respectively.

According to the present invention, the ON time of the light source is shortened to prevent an increase in temperature of the light source, thereby allowing life prolongation and power saving of the light source.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-277658 filed on Dec. 19, 2011, which is hereby incorporated by reference herein in its entirety.

1. An information processing apparatus comprising:
a projection unit configured to project a projection pattern generated by a display device onto a target object by turning on a variable ON/OFF light source;
an image capture unit configured to capture an image of the target object onto which the projection pattern is projected;
a calculation unit configured to calculate an image capture period of said image capture unit based on a response property of the display device and image capture characteristics of said image capture unit; and
a control unit configured to control to synchronize the image capture period of said image capture unit and a projection period of said projection unit by keeping the light source ON during the image capture period.

2. The apparatus according to claim 1, wherein
said image capture unit is capable of capturing an image for each partial area, and
said calculation unit calculates the image capture period based on the response property, the image capture characteristics, and the number of horizontal pixels and the number of vertical lines of an image sensor corresponding to the partial area.

3. The apparatus according to claim 1, wherein said calculation unit calculates the image capture period based further on a position of a white pattern of a white-black pattern which forms the projection pattern.

4. The apparatus according to claim 1, wherein the image capture characteristics include a pixel speed of the image sensor of said image capture unit.

5. The apparatus according to claim 4, wherein
said image capture unit operates in accordance with a rolling shutter scheme in which said image capture unit performs an image capture operation for each line, and
the image capture characteristics further include an exposure time for the each line, and a time taken for sensor information of the each line to be transferred from the image sensor to an external device.

6. The apparatus according to claim 1, wherein
the display device of said projection unit operates in accordance with a line-sequential driving scheme in which said image capture unit performs a projection operation for each line, and
the response property includes an offset time until projection for the each line becomes possible, a time difference of start of projection from an adjacent line for the each line, and an effective projection time for the each line, which indicates a time in which the projection pattern can be measured.

7. The apparatus according to claim 1, further comprising:
an area calculation unit configured to calculate the number of horizontal pixels and the number of vertical lines of an area, which does not overlap a projection area of said projection unit, of an image capture area of said image capture unit,
wherein said control unit controls to synchronize the image capture period of said image capture unit and the projection period of said projection unit by extending the image capture period by a time corresponding to the number of horizontal pixels and the number of vertical lines, and keeping the light source ON during the extended image capture period.

8. A control method for an information processing apparatus including a projection unit, an image capture unit, a calculation unit, and a control unit, the method comprising:
a projection step of causing the projection unit to project a projection pattern generated by a display device onto a target object by turning on a variable ON/OFF light source;
an image capture step of causing the image capture unit to capture an image of the target object onto which the projection pattern is projected;
a calculation step of causing the calculation unit to calculate an image capture period of the image capture unit based on a response property of the display device and image capture characteristics of the image capture unit; and
a control step of causing the control unit to control to synchronize the image capture period of the image capture unit and a projection period of the projection unit by keeping the light source ON during the image capture period.

9. A non-transitory computer-readable storage medium storing a computer program for causing a computer to execute each step in a control method for an information processing apparatus, defined in claim 8.
